(19) United States
(12) Patent Application Publication
(10) Pub. No.: US 2013/0270821 A1
(43) Pub. Date: Oct. 17, 2013

(54) COUPLING ASSEMBLY THAT ESTABLISHES A PIPE CONNECTION THROUGH PRESSURE CLAMPING

(71) Applicant: Gottfried Haener, Aesch (CH)

(72) Inventor: Gottfried Haener, Aesch (CH)

(21) Appl. No.: 13/906,071

(22) Filed: May 30, 2013

Related U.S. Application Data
(63) Continuation-in-part of application No. PCT/CN2012/079161, filed on Jul. 26, 2012.

(30) Foreign Application Priority Data
Apr. 12, 2012 (CN) 201220151938.X

(51) Int. Cl. F16L 13/14

(52) U.S. Cl. CPC F16L 13/146
USPC 285/382

(57) ABSTRACT

A coupling assembly for joining pipe ends includes a main body sleeve with a shoulder incorporating a sloped step. The main body sleeve has an inner surface with two claiming rings. The assembly further includes a swage ring which is moveable along the outer surface of the pipes. The inner surface of the swage ring includes ramps. The ramps force clamping rings to engage the pipe and form a seal as the swage ring is urged inward towards the main body sleeve. Additionally, the clamping ring includes a tab incorporating a sloped surface with a contour complementary to that of the sloped step. The surface of the clamping ring engages and presses against the surface of the sloped step, thus preventing movement of the swage ring away from the main body sleeve. The disclosure also pertains to a method of joining two pipes utilizing the disclosed coupling assembly.

### CROSS REFERENCE TO RELATED APPLICATIONS

This application is a continuation-in-part bypass of and claims priority under 35 U.S.C. 111(a) to International Application PCT/CN20121079161, with an international filing date of Jul. 26, 2012, which is incorporated herein by reference. International Application PCT/CN20121079161 claims priority to Chinese Application No. 201220151938.X, with a filing date of Apr. 12, 2012, which is incorporated herein by reference.

### RELATED ART

Pipe fitting involves the installation or repair of piping or tubing systems that convey liquid, gas and semi-solid materials. This work typically includes selecting and preparing pipe or tubing, joining it together by various means, and finding and repairing leaks. Pipe fitting work is done in many different settings, for example HVAC, manufacturing, and hydraulics. Joining pipes often involves the use of welding, soldering or bonding. Each of these methods presents various safety and environmental concerns, such as the risk of fire or explosion, exposure to dangerous chemicals, and ozone formation. In addition, these methods require extensive post-fitting treatments which are very labor intensive and costly. The welding, soldering and bonding methods add additional materials to the joined pipe, possibly dramatically increasing the weight of the final project.

Conduit couplings are often used in welding and other crafts to join the ends of pipes. Conduit couplings often utilize compression fittings, which are used in plumbing and electrical conduit systems to join two tubes or thin-walled pipes together. Swage fittings or rings are used to couple pipes carrying a variety of liquids or gasses. These couplings generally cause the deformation of a portion of the pipe and the fitting in response to the application of a compressive force. Swage fittings often utilize sealing projections or teeth to engage the pipe during installation. Generally, force is applied to the sealing teeth sequentially to reduce the installation force that would be required to seal the teeth simultaneously. The sequential application of compression force may cause a loss of bad force on one of the teeth, resulting in “kickback” or the development of a gap between the tooth and the underlying pipe. In addition, the sealing ability of traditional couplings may be compromised because of vibrations or other types of movements or forces, particularly under high pressure applications. These fittings would then require post-installation procedures which are both expensive and time consuming.

What is needed in the art, therefore, are coupling devices that provide improved sealing capability to prevent loss of the seal and costly, time consuming post-installation procedures.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a cross sectional view of the conduit coupling of the disclosure in a disengaged position.

FIG. 2 is a cross sectional view of the conduit coupling of the disclosure in an engaged position.

FIG. 3 is a cross sectional view of a swage ring engaged with a shoulder of a sleeve of a conduit coupling, as depicted by FIG. 2.

### DETAILED DESCRIPTION

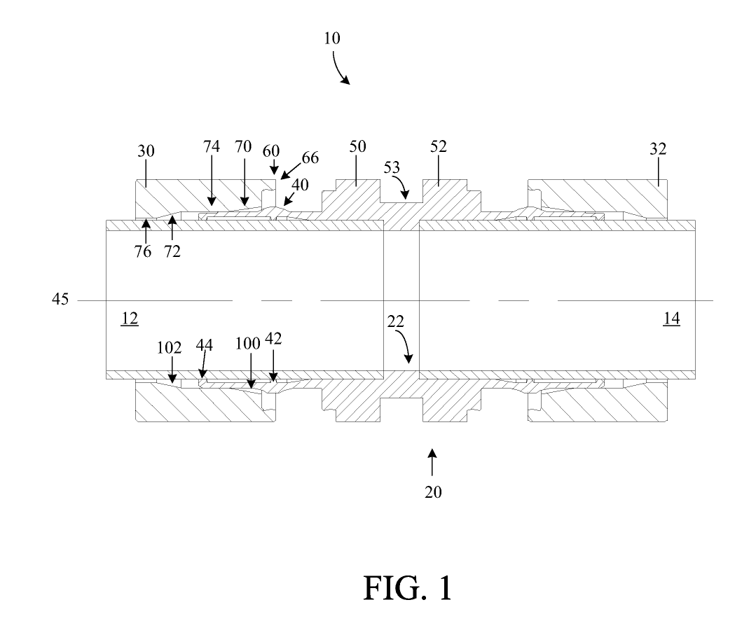

FIGS. 1 2, and 3 depict a cross section of a conduit coupling 10 utilized to join the respective ends of two pipes 12 and 14, As will be appreciated by one of skill in the art, the coupling has a ring-like shape and surrounds the exterior surface of pipes 12 and 14. Pipes 12 and 14 are constructed from any raw material suitable for piping as is known to one of skill in the art. For example, pipes 12 and 14 may be constructed from steel, steel alloys such as unfinished, black (lacquer) steel, carbon steel, stainless steel or galvanized steel, iron, brass, ductile iron, aluminum or copper. In one embodiment, pipes 12 and 14 are constructed from the same material. In an additional embodiment, the pipes 12 and 14 are constructed from differing materials such as metal and plastic. in one non-limiting example, the conduit coupling 10 may join pipes with a diameter between ¼ inch and 6 inches (4 mm to 168 mm). In an additional embodiment, the coupling 10 joins pipes of the same diameter. However, the disclosure is not limited in such a way as the conduit 10 may also join pipes with different diameters.

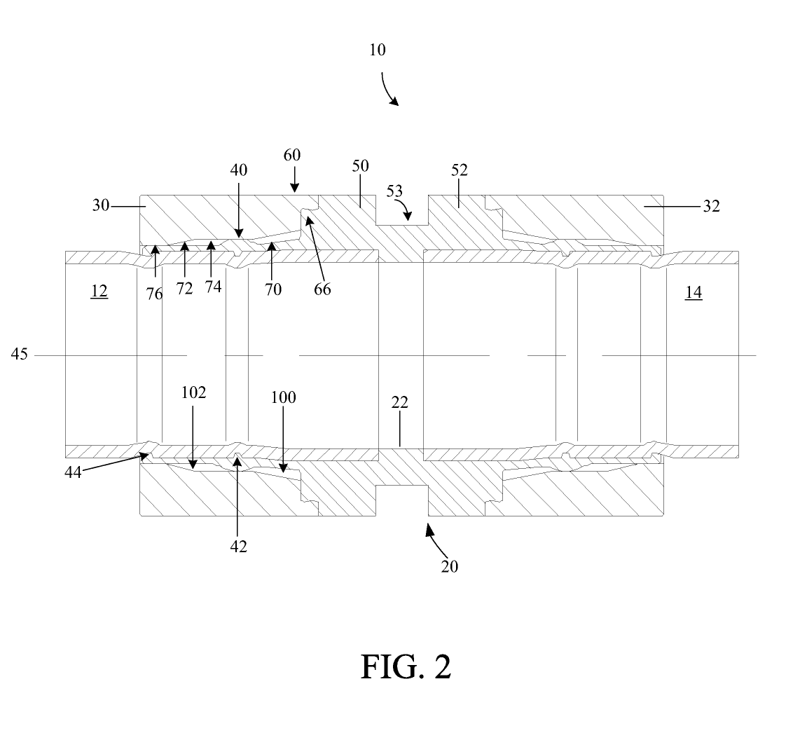

In the embodiment illustrated in FIGS. 1 and 2, conduit coupling 10 includes a main body cylindrical sleeve 20 which is adapted to receive the respective ends of pipes 12 and 14. Sleeve 20 fits over a terminal end of each pipe 12 and 14 in order to engage sealing elements and provide tight seals around pipes 12 and 14. The seal will prevent the leakage of both gasses and liquids at the junction of the two pipes. Cylindrical sleeve 20 includes a contoured outer surface. A stop 22 is located at the center of the sleeve 20 and projects partially into the interior of the pipes 12 and 14. The respective ends of pipes 12 and 14 abut against the protruding portion of stop 22 when they enter the sleeve 20, thus helping to stabilize the pipes during installation.

The conduit coupling 10 further includes two movable cylindrical swage rings 30 and 32. As will be described in greater detail below, a tool (not shown) applies inward compressing pressure along the entire circumference of swage rings 30 and 32. This inward compression pressure urges the swage rings 30 and 32 towards the center of the conduit, i.e., towards the main body sleeve 20 and stop 22. Swage rings 30 and 32 act to lock and seal the conduit coupling 10 onto the outer surface of tubes 12 and 14. As shown in FIG. 1, swage rings 30 and 32 are illustrated in the disengaged position, i.e., they have not been urged towards and do not yet contact main body sleeve 20. As will be discussed in greater detail below, FIG. 2 illustrates swage rings 30 and 32 in the engaged position as they are in contact with main body sleeve 20. Any description of one of swage rings 30 or 32 is applicable to the remaining swage ring.

Turning again to FIG. 1 illustrating disengaged swage rings 30 and 32, the bottom surface of each swage ring 30 and 32 has an inclined inner ramp 70 located immediately adjacent to and on the outward side of protrusion 40 (located on the upper surface of main body sleeve 20). The inclined nature of inner ramp 70 produces a space or area 100 where there is no contact between the swage ring 30 and the inner sleeve 20 as the sleeve 20 is urged to the engaged position. Moving outward towards the terminal ends of pipe 12, the swage ring 32 further includes an inner and 74 which is substantially parallel to line 45 and is located immediately adjacent to inner ramp 70. Also present on the bottom surface of swage ring 30 is an inclined outer ramp 72. Outer ramp 72 is immediately followed by outer and 76 which is substantially parallel to axis 45. Similar to the inner ramp 70, the inclined nature of outer ramp 72 produces a space or area 102 where there is no contact between the swage ring 30 and the inner sleeve 20 as the sleeve 20 is urged to the engaged position. Swage ring 32 includes similar corresponding structures.

The lower surface of the main body sleeve 20 includes an inner clamping ring 42 located directly opposite protrusion 40 and an outer clamping ring 44 located at the outer edge of sleeve 20. As will be described in more detail below, the inner clamping ring 42 and outer clamping ring 44 are shaped as protrusions which project down and contact the pipe 12. The inner clamping ring 42 and outer clamping ring 44 act as “teeth” and engage the outer surface of pipe 14, forming a seal between the pipe 14 and the conduit 10 when the sleeve 20 is urged to the engaged position. The portion of the main body sleeve 20 as illustrated in the engaged position (FIG. 2) has similar structure as described above.

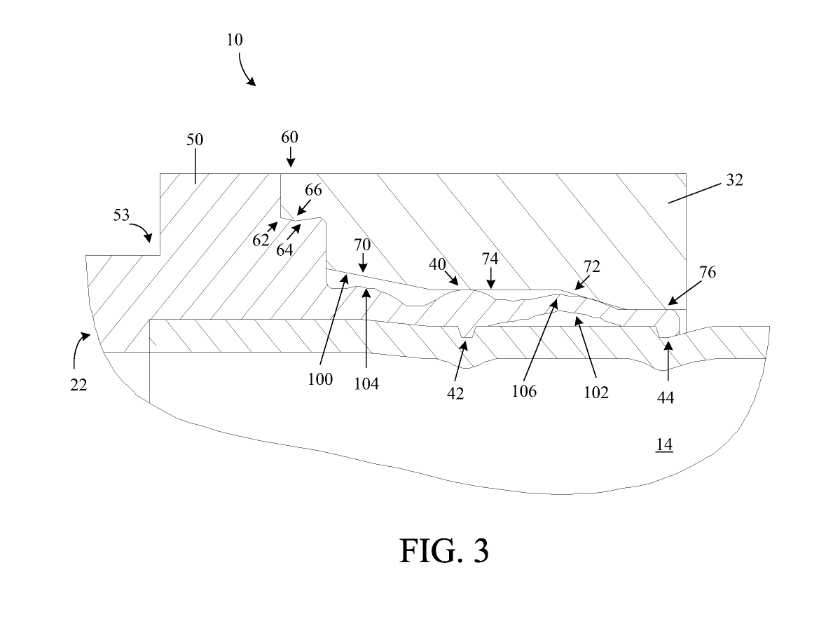

Referring again to FIG. 1, swage ring 30 further includes a retaining ring 60 with a sloped surface 66. Additionally, the upper surface of main body sleeve 20 includes shaft shoulders 50 and 52 that are separated by an annular groove 53. Shaft shoulder 50 further includes a step 62, which extends around the entire circumference of and at the edge of shaft shoulder 50. As illustrated in FIG. 1, the surface 64 of step 62 is sloped. As will be described in more detail below, the sloped surface 66 of retaining ring 60 is complementary to the sloped surface 64 of step 62. As the swage ring 12 is urged towards the sleeve 20, the two surfaces 66 and 64 make contact and are forced together into a locked orientation (FIGS. 2 and 3) that creates a tight fit and resists movement of the swage ring in a sidewise direction along line 45. In one embodiment, the surface 66 of retaining ring 60 is convex shaped (a surface that curves outward or downward), while the surface 64 of step 62 is concave. These two surfaces 64 and 64 have complementary corresponding structure so that they fit together snugly and are retained in a locked position during the application of force. In the presence of forces that tend to pull the swage ring 12 away from the shoulder 50, the surface 66 of the retaining ring 60 presses against the surface 64 of the step 62 in response to such forces thereby resisting movement of the swage ring 12 away from the shoulder 50. The portion of the main body sleeve 20 as illustrated in the engaged position (FIGS. 2 and 3) has similar structure as described above.

In practice, the two opposing ends of pipes 12 and 14 are placed adjacent to the interior surface of the sleeve 20. The ends of pipes 12 and 14 are inserted into opposite ends of the sleeve 20 so that the conduit 10 is fitted externally around the circumference of pipes 12 and 14. The inner clamping ring 42 and outer clamping ring 44 contact the exterior surfaces of pipes 12 and 14. As described previously, the pipes 12 and 14 may be constructed from any material suitable for conveying a fluid, gas or semi-solid, as is known to one of skill in the art. The diameters of conduit 10 and sleeve 20 are sized such that they fit snugly over the ends of pipes 12 and 14. During insertion, the respective ends of pipes 12 and 14 move towards the midpoint of sleeve 20 until each abuts against opposing sides of protruding portion of stop 22. In the disengaged position illustrated in FIG. 1, the inner ramp 70 and the inner land 74 are located immediately adjacent to and on the outward side of the protrusion 40. Outer ramp 72 and outer land 76 are located on the portion of the swage ring 32 located after the termination of the sleeve 20. The pipes 12 and 14 may be of any diameter desired for its intended use, and the diameter of the ends of sleeve 20 may be of any diameter desired to accommodate pipes 12 and 14. No lubrication or pretreatment of the pipes 12 and 14 is necessary. The conduit 10 is fitted externally around the respective ends of pipes 10 and 12, resulting in no change to the internal diameter of the pipes 12 and 14.

A swage press tool (not shown) utilized for installation of the conduit 10, as is known to one of skilled in the art, is placed over sleeve 20. Axial force is applied to sleeve 20 via the press tool (not shown). This compressing force urges swage rings 30 and 32 inward towards the center of sleeve 20 to their final engaged positions as shown by FIGS. 2 and 3. Turning again to FIG. 1, the axial force applied by the press tool (not shown) causes a compressive force on swage rings 30 and 32. This force urges swage rings 30 and 32 inward toward the center of the sleeve 20. This movement causes the inner ramp 70 to contact protrusion 40 and provide a continuous force against protrusion 40 as the sleeve moves towards the shaft shoulders 50 and 52. FIGS. 2 and 3 illustrate an additional embodiment of conduit 10 with fully engaged swage rings 30 and 32. As illustrated in FIG. 2, the force exerted on the protrusion 40 by the inner ramp 40 pushes the inner ramp 70 over and to the inward side of protrusion 40. As shown in FIG. 3, such force causes a deformation of the sleeve 20, including specifically areas 104 and 106 on opposite sides of the protrusion 40. This propels a deformation area 104 of the sleeve 20 into the space 100. The unoccupied areas of 100 and 102 allow unrestricted buckling or deformation of the areas 104 and 106. The compressive force applied by the swage rings 30 and 32 causes the inner damping ring 42 (FIGS. 2 and 3) to bite into the outer surface of pipe 14, creating a seal between the sleeve 20 and pipe 14.

Referring again to unengaged swage rings 30 and 32 illustrated in FIG. 1, as inner clamping ring 42 continues to bite into the pipes 12 and 14, swage rings 30 and 32 are further urged inward relative to the main body 20 along line 45 until at least the inner land 74 makes contact with the protrusion 40. As shown in FIG. 2, only inner ramp 70 and inner land 72 engage protrusion 40. The axial pressure provides a continuous force on the sleeve 20. As illustrated in FIG. 3, such force causes a deformation of the sleeve 20, including specifically areas 104 and 106 on opposite sides of the protrusion 40. This propels a deformation area 104 of the sleeve 20 into the space 100. The unoccupied areas of 100 and 102 allow unrestricted buckling or deformation of the areas 104 and 106, as shown by FIG. 3. The compressive force applied by the swage rings 30 and 32 causes the inner clamping ring 42 (FIG. 2) to bite into the outer surface of pipe 14, creating a seal between the sleeve 20 and pipe 14. The downward biting force of outer clamping ring 44 continues as the swage ring 32 is further urged relative to the main body 20 until the inner land 76 is placed above and engages the terminal end of sleeve 20. Only ramp 43 and land 44 engage such end of the main body 20 where the outer clamping ring 44 is located.

As illustrated in FIGS. 1-3, the outer ramp 72 engages the end of main body 20 after the inner ramp TO engages the protrusion 40 such that the outer clamping ring 44 bites into the outer surface of pipe 14 after the inner clamping ring 42. Specifically, as the swage ring 32 (or 30) presses inward, the inner clamping ring 42 begins biting into the pipe 14 first, followed by the biting of outer clamping ring 44. Pressure from swage ring 32 then causes the inner clamping ring 42 and the outer clamping ring 44 to simultaneously bite into the outer surface of pipe 14. The spaces 100 and 102 provide discontinuous contact between the sleeve 20 and the exterior surface of pipe 12 and 14. In particular, spaces 100 and 102 allow unrestricted deformation or buckling in the areas 104 and 106 (FIG. 3). Moreover, restriction of such deformation and buckling could otherwise result in a kickback force that tends to force the clamping ring 42 away from the pipe 14. In addition, continuous application of a force on the protrusion 40 by the ramp 70 during biting of the outer clamping ring 44 helps to keep the inner clamping ring 42 pressed against the pipe 14 in the presence of any kickback force. The biting of the clamping rings 42 and 44 provides a sequential gas- and liquid-tight seal and locks the conduit assembly 10 onto the pipes 12 and 14 with a minimal loss of compression force. Kickback of the first clamping ring (inner clamping ring 42) is prevented in part because of a continuous load force being applied to the inner clamping ring 42 by the ramp 70 while the outer ramp 72 is causing the outer clamping ring 44 to bite into the pipe. Retraction of the assembly is prevented even under high pressure applications or with excessive vibrations.

Referring again to FIG. 1, the axial force provided by the press tool (not shown) urges swage rings 30 and 32 inward towards the protruding portion of stop 22 where they contact shaft shoulders 50 and 52. As previously detailed, step 62 of sleeve 20 is dimensioned to receive retaining ring 60 of the swage ring 30. Swage ring 32 has similar corresponding structure. As shown in FIGS. 1 and 2, the surface 64 of step 62 and the surface 66 of retaining ring 60 are sloped or shaped in a complementary manner and provide complementary conformations. In one embodiment, surface 64 is concave (slopes downward and then upward) while the surface 66 convex (protrudes outward). It will be understood by one of skill in the art that other complementary shapes are contemplated by the present disclosure. In this embodiment, the convex contour 66 of the retaining ring 60 corresponds to the concave shaped surface 64 of step 62. These two complementary shaped surfaces fit snugly together and lock into place. As a result, a tight tit occurs between the retaining ring 60 and the step 62, Because the retaining ring 60 and the step 62 are securely held in a locked position, movement of the swage ring 30 in an outward direction along line 45 is prevented. This reduces the possibility of a reduction of the force exerted onto the inner clamping ring 42 and outer clamping ring 44 by the swage rings 30 and 32. Specifically, the locking nature of the retaining ring 60 and the step 62 retains the swage rings 30 and 32 in an engaged position (illustrated in FIGS. 2 and 3) and prevents disengagement (illustrated in FIG. 1) of the clamping rings 42 and 44 from the exterior surface of pipes 12 and 14. The secure connection between the retaining ring 60 and the step 62 allows assembly 10 to withstand greater external forces, such as vibrations, that otherwise could result in loosening and eventual failure of the connection.

The assembly 10 of the present disclosure joins pipes of varying construction and with a variety of sizes. The assembly 10 eliminates the need for soldering, welding, bonding or the use of screws, reducing installation time and eliminating any change in the inner pipe diameter. The conduit 10 may also be installed in any medium and at any temperature because it is a metal fitting. Greater installation force may be used to connect conduit 10 without the threat of loss of load force or kickback of the sequentially biting teeth. Loss of load force is also prevented because the conduit 10 provides for a secure locking mechanism which prevents retraction of the swage rings 30 and 32 in a direction away from the sleeve 20. This reduces the need for additional or repeated tightening steps, cutting installation and supply costs. In additional, the absence of welding or bonding prevents the accumulation of weld slag inside the pipes, eliminating the need for pipes pigging, pickling, flushing or other expensive post-installation steps.

Now, therefore, the following is claimed:

1. A conduit coupling, comprising:
a main body sleeve having an opening for receiving an end of a pipe, the main body sleeve having a shoulder, wherein the shoulder has a step at an edge of the shoulder, and wherein a surface of the step is sloped, the main body sleeve having an outer surface and an inner surface, wherein the inner surface defines a first clamping ring and a second clamping ring; and
a swage ring having an inner surface forming a first ramp and a second ramp, the first ramp positioned for engaging a protrusion of the outer surface of the main body sleeve as the swage ring is urged toward the shoulder such that the first clamping ring bites into the pipe forming a seal around the pipe, the second ramp positioned for engaging the outer surface of the main body sleeve as the swage ring is urged toward the shoulder such that the second clamping ring bites into the pipe forming a seal around the pipe, wherein the swage ring has a tab for engaging the step, the tab extending from a side of the swage ring facing the shoulder.

2. The conduit coupling of claim 1, wherein the tab has an inner surface defining a retaining ring for engaging the step such that the retaining ring presses against the surface of the step to resist movement of the swage ring away from the shoulder.

3. The conduit coupling of claim 2 wherein the inner surface of the tab has a convex shape.

4. The conduit coupling of claim 3, wherein the surface of the step has a concave shape.

5. The conduit coupling of claim 1, wherein the tab has a sloped inner surface for engaging the surface of the step such that the sloped inner surface of the tab presses against the surface of the step to resist movement of the swage ring away from the shoulder.

6. A method of joining ends of a plurality of pipes, the method comprising:
inserting the ends of the plurality of pipes into a main body sleeve, the main body sleeve having a shoulder, wherein the shoulder has a step at an edge of the shoulder, and wherein a surface of the step is sloped, the main body sleeve having an outer surface and an inner surface, wherein the inner surface defines a first clamping ring and a second clamping ring and the outer surface defines a protrusion:
applying axial force to swage ring urging a swage ring toward the shoulder, the swage ring having an inner surface forming a first ramp and a second ramp and wherein the swage ring has a tab extending from a side of the swage ring facing the shoulder, wherein the tab has a sloped inner surface,
engaging the first ramp of the swage ring inner surface with the protrusion of the outer surface of the main body sleeve such that the first clamping ring bites into the pipe forming a seal around the pipe;
engaging the second ramp with the outer surface of the main body sleeve such that the second clamping ring bites into the pipe forming a seal around the pipe, and
engaging the sloped inner surface of the tab with the sloped surface of the step such that the sloped inner surface of the tab presses against the surface of the step to resist movement of the swage ring away from the shoulder.

7. The method of claim 6, wherein the sloped inner surface of the tab defines a retaining ring for engaging the step such that the retaining ring presses against the sloped surface to resist movement of the swage ring away from the shoulder.

8. The method claim 7, wherein the sloped inner surface of the tab has a convex shape.

9. The method of claim 7, wherein the sloped surface of the step has a concave shape.

10. A conduit coupling, comprising:
a main body sleeve having an opening for receiving an end of a pipe, the main body sleeve having a shoulder, wherein the shoulder has a step at an edge of the shoulder, the main body sleeve having an outer surface and an inner surface, wherein the inner surface defines a first clamping ring and a second clamping ring; and
a swage ring having an inner surface forming a first ramp and a second ramp, the first ramp positioned for engaging a protrusion of the outer surface of the main body sleeve as the swage ring is urged toward the shoulder such that the first clamping ring bites into the pipe forming a seal around the pipe, the second ramp positioned for engaging the outer surface of the main body sleeve as the swage ring is urged toward the shoulder such that the second clamping ring bites into the pipe forming a seal around the pipe, wherein the swage ring has a tab for engaging the step, the tab extending from a side of the swage ring facing the shoulder, wherein a surface of the step and the tab are shaped such that when the tab is engaged with the step, the tab presses against the surface of the step in response to a force tending to separate the swage ring from the shoulder thereby resisting movement of the swage ring from the shoulder.
